(19) United States
(12) Patent Application Publication
(10) Pub. No.: US 2021/0362243 A1
(43) Pub. Date: Nov. 25, 2021

(54) THREE-DIMENSIONAL PRINTING

(71) Applicant: HEWLETT-PACKARD DEVELOPMENT COMPANY, L.P., Spring, TX (US)

(72) Inventors: Sergio Puigardeu Aramendia, Corvallis, OR (US); Michael G. Monroe, Corvallis, OR (US); Jason C. Hower, Corvallis, OR (US)

(21) Appl. No.: 16/605,206

(22) PCT Filed: Jul. 27, 2018
(86) PCT No.: PCT/US2018/044137

§ 371 Date: Oct. 14, 2019

(51) Int. Cl. B22F 12/55; B22F 10/14; B22F 10/30; B33Y 10/00; B33Y 30/00; B33Y 50/02; B29C 64/165; B29C 64/209; B29C 64/393

(52) U.S. Cl. CPC B22F 12/55; B22F 10/14; B22F 10/30; B33Y 10/00; B29C 64/393; B33Y 50/02; B29C 64/165; B29C 64/209; B33Y 30/00

(57) ABSTRACT

An example three-dimensional printing method is described, comprising selectively depositing droplets of a liquid agent on a layer of build material, by depositing liquid agent on the layer of build material from a first distance above the layer, for example on a first part of the layer, and depositing liquid agent on the layer of build material from a second distance above the layer, for example on a second part of the layer. An example 3D printer is also described.

### BACKGROUND

Additive manufacturing techniques, such as three-dimensional printing, relate to techniques for generating three-dimensional objects on a layer-by-layer basis. An object may be generated by selectively solidifying successive layers of a build material, for example build material in powder form.

Droplets of a liquid agent may be deposited on each layer of a build material. In some techniques, droplets of a liquid agent may be deposited on a layer of build material according to a predetermined pattern, which may depend on the shape of the 3D body being manufactured.

### BRIEF DESCRIPTION OF THE DRAWINGS

Some non-limiting examples of the present disclosure will be described in the following with reference to the appended drawings, in which:

FIG. 1 shows a flowchart of an example three-dimensional printing method according to the present disclosure;

FIGS. 2a, 2b and 2c are schematic diagrams showing example patterns of a layer of an object that may be manufactured by example methods disclosed herein;

FIGS. 3, 4 and 5 show simplified views of some components of example three-dimensional printers according to implementations disclosed herein;

FIGS. 6, 7 and 8 are flowcharts of example three-dimensional printing methods according to the present disclosure;

FIG. 9 shows a simplified view of some components of another example three-dimensional printer as disclosed herein.

### DETAILED DESCRIPTION

When forming an object by three-dimensional printing, a layer of a build material such as powder may be laid out on a working area, for example a build platform, and an agent may be selectively applied on regions of the layer of build material. An agent may be applied for example on regions of the layer of build material where the build material is meant to solidify to form a layer of the object.

For example, droplets of a liquid agent may be deposited on the layer of build material according to a predetermined pattern, which may depend on the shape of the three-dimensional object or body being manufactured, for example on the shape of one layer of the object. The droplets may be deposited from a delivery device, such as for example a printhead, which may be mounted to scan over the build platform or working area.

The regions of the layer of build material on which a liquid agent has been applied may then be caused to solidify and/or bind together, for example by applying heat and/or by the binding properties of the liquid agent.

When a layer is completed, the build platform may be lowered by predetermine height, for example 0.1 mm, and another layer of build material may be laid on top of the previously completed layer, selectively printed with a liquid agent and caused to solidify as described. The process is repeated, layer by layer, until the object to be manufactured in completed.

In some examples, agents are selectively applied on regions of a layer of build material in two or more passes of a delivery device over the layer of build material.

When droplets of a liquid agent are deposited on a build material in power form, the impact of the droplets may cause some of the build material to splash, i.e. to be displaced. Splashing may cause erosion and alterations in the layer of build material, which may reduce the precision of the part being manufactured. Splashing may also project particles of the build material towards the delivery device, for example a printhead, and may affect the operation of the delivery device.

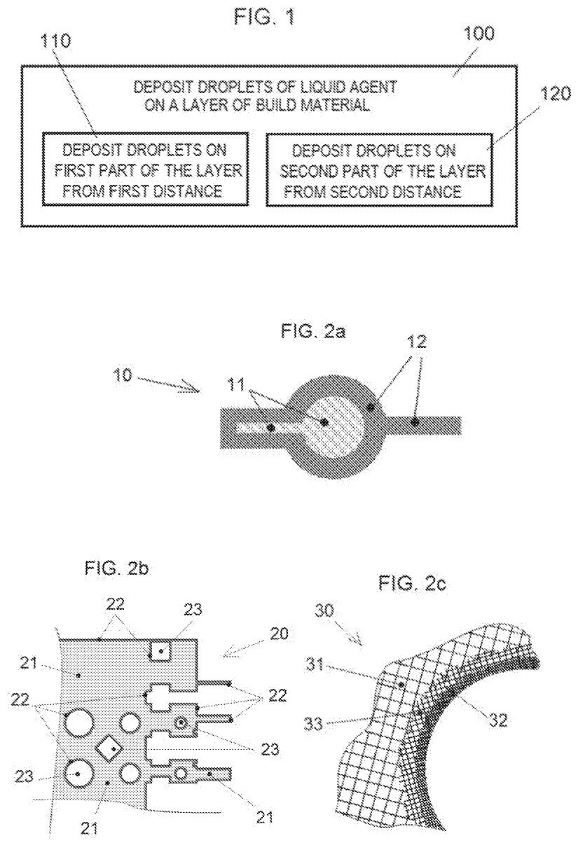

According to an example, as shown in FIG. 1, three-dimensional objects can be generated with a printing method according to the present disclosure by, in block 100, selectively depositing droplets of a liquid agent on a layer of build material: this may be done by depositing liquid agent, in block 110, on a first part of the layer of build material from a first distance above the layer, and, depositing liquid agent, e.g. the same liquid agent, in block 120, on a second part of the layer of build material from a second distance above the layer. The second distance may be greater than the first distance.

The distance above the layer from which the droplets of liquid agent are deposited is herein defined as the vertical distance between the lower active part of a delivery device, such as a printhead nozzle, and the upper surface of the layer of build material, e.g. the surface as spread by a recoater device on a build platform or on a previous layer. In 3D printing methods that employ powder build material and printheads, this distance is sometimes referred to as “Printhead to Powder Distance” (PPD) or “Printhead to Powder Space” (PPS).

Splashing depends on several variables, such as the material of the layer or the size of the liquid agent droplets, and also on the distance from which the droplets are deposited, e.g. fired from a nozzle such as a printhead nozzle. With a greater distance, there is more dispersion of the droplets of liquid agent when they reach the build material, and therefore, with a greater distance the drop energy when the droplets impact the layer is smaller, and less splashing is likely to occur. For example, droplets fired from a printhead nozzle at a distance of about 1.3 to 2.3 mm above the build material may undergo a deviation or dispersion of about 10 to 20 μm, while droplets fired at a distance of about 3 mm may undergo a deviation or dispersion of about 150 to 400 μm.

In methods as disclosed herein, splashing may be reduced by depositing the liquid agent from a greater distance on some parts of the layer of build material. This may reduce the overall splashing in the layer of build material, such that the delivery device may receive less amount of splashed build material. This allows for less maintenance and increased accuracy in the operation of the delivery device and therefore in the deposit of droplets.

For example, droplets may be deposited from a first, smaller distance which involves a more precise positioning of the droplets, on parts of the layer corresponding to parts of the 3D object being manufactured in which a higher droplet positioning accuracy is desired or useful, for example because these parts are on or near the outer surfaces of the finished object.

Droplets may be deposited from a second, greater distance on parts of the layer of build material corresponding to other parts of the 3D object being manufactured, such as for example the core of the object, which is not near the visible parts of the finished product, so that the positioning accuracy of the droplets in the core region has no effect on the quality, in particular on the dimensional properties or the surface uniformity, of the finished object.

Since often the core of a 3D object may occupy most of the surface area of most layers of build material, example methods as described herein may allow to significantly reduce splashing and its effects, while maintaining the quality of the finished object, e.g. dimensional accuracy, details in small parts, surface uniformity and/or smoothness, etc. Furthermore, the solution is cost-effective and easy to implement.

In example 3D printing methods, droplets may be deposited on each layer of build material according to a predetermined pattern associated with a corresponding layer of the 3D body or object being manufactured, e.g. wherein the pattern may have the same shape as the layer of the object. Droplets may be deposited from a first, smaller distance in at least a core region of the pattern, and from a second, greater distance in at least an edge region of the pattern.

For example, FIG. 2a shows a pattern 10 for one of the layers of an object or body which can be manufactured with example methods as disclosed herein. Pattern 10 may comprise a core region 11, shown with a light hatching in FIG. 2a, and edge regions 12, shown with a dark hatching in FIG. 2a. When manufacturing the layer of the object corresponding to this pattern 10, droplets of liquid agent may be deposited on the layer of build material from a first, smaller distance in the core region 11 and from a second, greater distance in the edge regions 12. By edge regions it is meant herein the edges of the part, but in certain cases, also parts of the object, such as projecting parts, that are relatively thin with respect to other parts of the object, like for example the projection on the right side of the pattern 10 of FIG. 2a.

FIG. 2b is a partial view of another example of a pattern 20 for one of the layers of an object or body to be manufactured. Pattern 20 may comprise core regions 21 and may comprise edge regions 22, some of the edge regions 22 around cavities or recesses 23 of the object. In this example, the edge regions that have been defined are narrower than in the case of pattern 10 of FIG. 2a. When manufacturing the layer of the object corresponding to this pattern 20, droplets of liquid agent may be deposited from a first, smaller distance in core regions 21, and from a second, greater distance in the edge regions 22.

In some examples, the core and edge regions of each layer of build material where droplets may be deposited from a first or a second distance may be determined in each case based on a number of parameters such as the build material and the liquid agent being used, the kind of delivery device and the intended printing distance, the size of the droplets, the desired dimensional accuracy of the finished product, and/or others. The dimensions of the core and edge regions, as well as the first and second distances and/or the difference between the first and second distance, may be determined, for instance, through testing, modelling and/or interpolation, so that the combination of the degree of dispersion of the droplets and the dimension of the edge regions maintains continuity in the presence of liquid agent between the core and the edge regions, and at the same time prevents the droplets deposited in the core regions from being dispersed beyond the edge of the pattern or object.

In some implementations, where the first distance may be e.g. of about 1.0 to 2.5 mm, for example 1.3 to 2.3 mm, the second distance may be set to about to 2.5 to 3.5 mm, for example about 3 mm. In such implementations, the width of the edge regions of each layer, i.e. the dimension of the edge regions in a direction substantially perpendicular to the direction of the edge of the pattern or of the object in that layer, may be for example of about 1 to 3 mm.

In implementations of methods disclosed herein, the first part or core region of the layer of build material where liquid agent is deposited from the first distance and the second part or edge region of the layer of build material where liquid agent is deposited from the second distance, may have a degree of overlap. In other words, there may be a transitional or intermediate region where droplets are deposited from both the first distance and the second distance, or where droplets are deposited from a first distance, but a certain amount of liquid agent belonging to droplets deposited from the second distance also reach this intermediate region due to the dispersion of the droplets deposited from the second distance.

FIG. 2c is an enlarged, partial and very schematic view of another example of a pattern 30 for one of the layers of an object or body to be manufactured. Pattern 30 may comprise core regions 31 and may comprise edge regions 32, and transition or intermediate regions 33. The depiction and dimension of each region and of the boundaries between the regions are purely schematic and non-limiting. The liquid agent density in intermediate regions may be higher or lower than in edge regions.

Build materials suitable to be employed in method as disclosed herein may be in the form of a powder. The powder may be formed of any suitable material including, but not limited to, metals, polymers, ceramics, or any other that may be employed as build material in three-dimensional printing, as well as combinations of these or other materials.

Some implementations of methods according to the present disclosure may be particularly useful for example with metal powder as build material. Metal particles may be smaller and lighter than those of e.g. plastic materials, and they do not significantly increase in viscosity with the temperatures that are used in 3D printing, and therefore metal powder build material may be more affected by splashing than for example plastic powder. For example, the build material may be stainless steel powder, aluminium powder, or others. Ceramic powders, for example alumina, or build materials comprising combinations of two different materials, may also be employed in some implementations of the method.

The liquid agent may be any agent suitable for the three-dimensional printing process and the build material being used. For example, the liquid agent may be a binding agent, such as latex, for example suitable for binding a metal powder, e.g. to form a green body to be later sintered or cured by any other method. The liquid agent may be any other binder, e.g. a chemical binder. It may also be a fusing agent or a detailing agent, or any other agent used in 3D printing. For example, the liquid agent may have a latex load of about 5 to 20%.

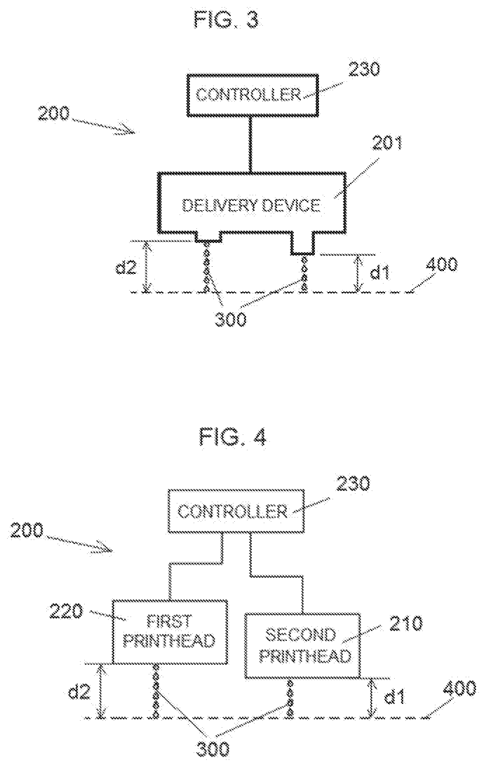

In FIG. 3 a three-dimensional (3D) printer 200 according to some implementations of the present disclosure is represented. The 3D printer may comprise a delivery device 201 to selectively deposit droplets 300 of a liquid agent on a layer 400 of build material, which may be under the delivery device 201, and a controller 230 to control the delivery device 201 to selectively deposit droplets of the liquid agent from at least two different distances d1 and d2 on the layer 400 of build material.

In some implementations of a 3D printer as disclosed herein, the 3D printer may manufacture a 3D body or object by selectively solidifying successive layers of build material according to a predetermined pattern, such as described above by way of example in FIGS. 2a and 2b, for each layer of build material. The controller 230 of the 3D printer may determine a core region and an edge region of the predetermined pattern for a layer of build material and control the printer to deposit droplets of a liquid agent on the layer of build material from a first distance in correspondence with the core region of the pattern, and from a second distance in correspondence with the edge region of the pattern.

In some implementations, such as represented in FIG. 4, the 3D printer may comprise a first printhead 210 and a second printhead 220, and the controller 230 may operate the printheads to deposit droplets 300 on the layer 400 of build material from the first distance d1 with the first printhead 210, and deposit droplets 300 on the layer 400 of build material from the second distance d2 with the second printhead 220.

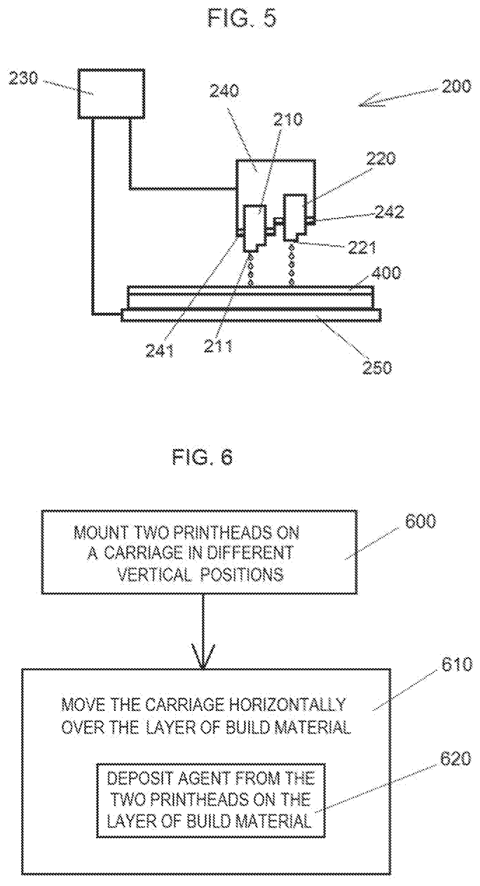

FIG. 5 represents some implementations of a 3D printer 200 which may comprise a delivery device comprising printheads 210 and 220 mounted on a carriage 240. The carriage 240 may be controllable by the controller 230 to scan in a horizontal direction over the layer 400 of build material. The 3D printer 200 may comprise a build platform 250 on which the layer 400 of build material may be spread. The build platform 250 may be controllable by the controller 230 to be raised or lowered, for instance to be lowered after a layer of build material has been completed and a new layer of build material has to be spread on the completed layer.

In some examples of 3D printers according to the present disclosure, such as also shown in FIG. 5, printhead 210, with first agent ejecting nozzles 211, and printhead 220, with second agent ejecting nozzles 221, may be mounted in different vertical positions on the carriage 240: for example, the carriage 240 may comprise mounting sockets 241 and 242 for the printheads 210 and 220, at two different vertical levels with respect to the horizontal scanning plane of the carriage, and therefore at two different vertical levels above the layer 400 of build material and above the build platform 250.

FIG. 6 is a flowchart of some implementations of 3D printing methods according to the present disclosure, which may comprise, in block 600, mounting two printheads on a carriage for horizontal movement over a layer of build material, in different vertical positions, such as shown in the example of FIG. 5. In block 610, the carriage may be moved horizontally over the layer of build material, and in block 620 droplets of liquid agent are deposited, e.g. fired, from one printhead, at one distance over the layer of build material, and from the other printhead, at another distance over the layer of build material. The droplets of liquid agent may be fired from both printheads and deposited on the layer of build material, from two different distances, in the same pass of the carriage over the layer, i.e. substantially simultaneously. Each printhead may fire droplets selectively, according to a part of a predetermined pattern, the predetermined pattern corresponding to the shape of a layer of the object that is being manufactured. For example, the liquid agent may be deposited on edge regions of the predetermined pattern by the printhead at a smaller distance from the layer of build material, and on core regions of the predetermined pattern by the printhead at a greater distance from the layer of build material.

Some examples of implementations of 3D printers and 3D printing methods as disclosed above, e.g. involving two printheads mounted in different positions on a carriage allow decreasing splashing of the build material, while maintaining a high throughput in the manufacturing process.

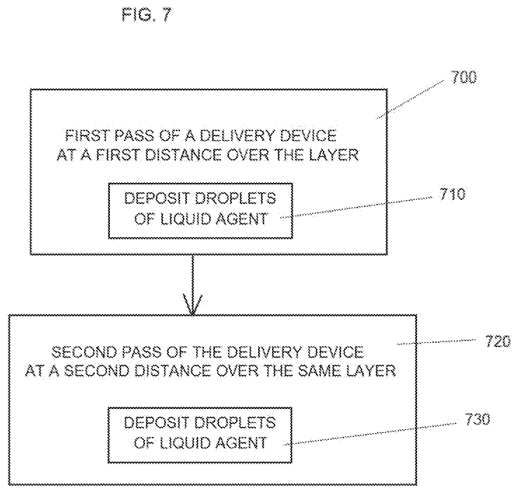

FIG. 7 is a flowchart of some implementations of 3D printing methods according to the present disclosure, which may comprise, in block 700, performing a first pass of a delivery device at a first distance over the layer of build material, and in block 710 depositing droplets of liquid agent in the first pass. The method may then comprise, in block 720, performing a second pass of the delivery device at a second distance over the same layer of build material, and in block 730 depositing droplets of liquid agent in the second pass. In each pass, the delivery device, e.g. a printhead, may deposit liquid agent selectively, following part of a predetermined pattern, the corresponding to the shape of a layer of the object that is being manufactured. For example, the liquid agent may be deposited on edge regions of the predetermined pattern in one pass, with the delivery device closer to the layer of build material, and on core regions of the predetermined pattern in the other pass, with the delivery device at a greater distance from the layer of build material.

In some implementations of methods according to FIG. 7, between the first pass and the second pass the delivery device, for example a printhead, may be displaced upwards or downwards, to vary the distance between the delivery device and the layer of build material. This may be done for example by providing two positioning references between the printheads and the carriage: i.e. providing two references at different levels on a carriage, for inserting two printheads having the same reference, or providing two references at the same level on a carriage, for inserting two printheads having references at different levels.

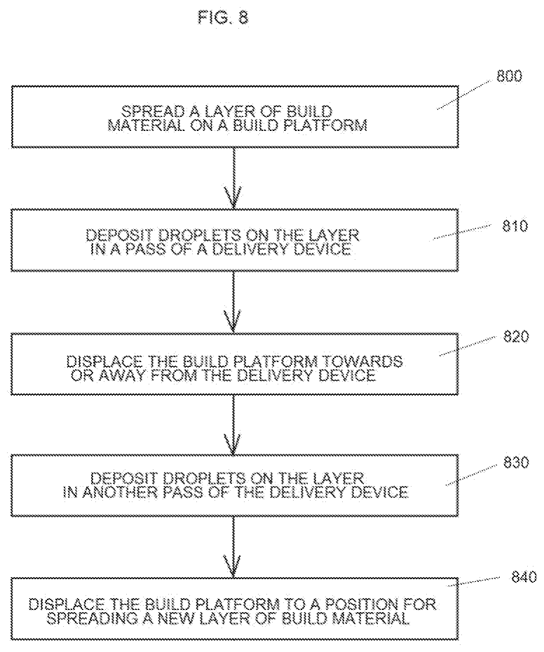

In some implementations of methods according to FIG. 7, between the first pass and the second pass the layer of build material may be displaced upwards or downwards, to vary the distance between the delivery device and the layer of build material. For example, FIG. 8 represents a flowchart of three-dimensional printing methods according to some implementations, comprising: in block 800, spreading a layer of build material on a build platform; in block 810, depositing droplets on the layer of build material in a pass of a delivery device over the build platform; in block 820, displacing the build platform towards or away from the delivery device; and, in block 830, depositing droplets on the layer of build material in another pass of the delivery device over the build platform. Then, in block 840, the build platform may again be displaced vertically to the position intended for spreading the following layer of build material.

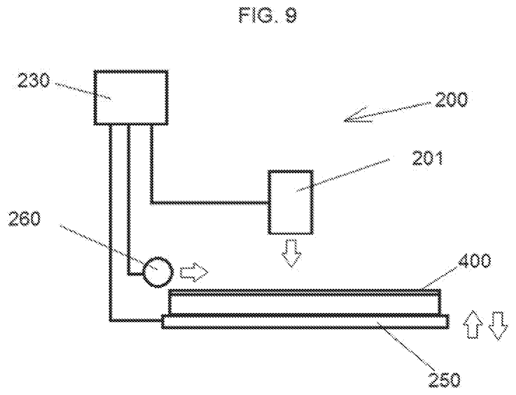

FIG. 9 shows an example of a three-dimensional printer 200 comprising a build platform 250, a coater 260, for example in the form of a roller, to form successive layers 400 of build material on the build platform 250, a delivery device 201 to selectively deposit droplets of a liquid agent on each layer of build material, and a controller 230. The controller 230 may successively control the coater 260 to spread or form a layer 400 of build material on the build platform 250, control the delivery device 201 to selectively deposit droplets of a liquid agent on the layer 400 of build material, control the build platform 250 to move vertically, towards the delivery device 201 or away from the delivery device 201, and control the delivery device 201 to selectively deposit droplets of a liquid agent on the same layer 400 of build material. The controller 230 is therefore controlling the three-dimensional printer 200 to deposit liquid agent on a layer of build material from two different distances, in two successive passes of the delivery device over the layer of build material.

Although a number of particular implementations and examples have been disclosed herein, further variants and modifications of the disclosed devices and methods are possible. For example, not all the features disclosed herein are included in all the implementations, and implementations comprising other combinations of the features described are also possible.

What is claimed is:

1. A three-dimensional (3D) printing method, comprising selectively depositing droplets of a liquid agent on a layer of build material, by:
depositing liquid agent on a first part of the layer of build material from a first distance above the layer, and
depositing liquid agent on a second part of the layer of build material from a second distance, greater than the first distance, above the layer.

2. The method according to claim 1, wherein depositing the droplets of the liquid agent comprises:
depositing the droplets on the layer of build material according to a pattern associated with the 3D body being manufactured, the pattern comprising core regions and edge regions, and
depositing the droplets from the first distance in at least a core region of the pattern, and from the second distance in at least an edge region of the pattern.

3. The method according to claim 1, wherein depositing the droplets of the liquid agent comprises:
depositing the droplets from the first distance with a printhead, and
depositing the droplets from the second distance with another printhead.

4. The method according to claim 3, comprising mounting two printheads in different vertical positions on a carriage, moving the carriage horizontally over the layer of build material, and depositing droplets of liquid from both printheads on the layer of build material, in the same pass of the carriage over the layer of build material.

5. The method according to claim 1, wherein depositing the droplets of the liquid agent comprises:
depositing the droplets from the first distance in a pass of a delivery device over the layer of build material, and
depositing the droplets from the second distance in another pass of the delivery device over the same layer of build material.

6. The method according to claim 5, comprising displacing the delivery device towards or away from the layer of build material between one pass and the other.

7. The method according to claim 5, comprising displacing the layer of build material towards or away from the delivery device between one pass and the other.

8. The method according to claim 7, comprising forming successive layers of build material on a build platform and, for each layer of build material, depositing droplets on the layer of build material in a pass of a delivery device over the build platform,
displacing the build platform towards or away from the delivery device, and
depositing droplets on the layer of build material in another pass of the delivery device over the build platform.

9. The method according to claim 1, wherein the build material comprises metal powder.

10. The method according to claim 1, comprising depositing droplets of liquid agent from the first distance and from the second distance in an intermediate part of the layer of build material between the first part and the second part.

11. A three-dimensional (3D) printer comprising:
a delivery device to selectively deposit droplets of a liquid agent on a layer of build material, and
a controller for controlling the delivery device to selectively deposit droplets of the liquid agent from at least two different distances on the same layer of build material.

12. A printer as claimed in claim 11, comprising a build platform for supporting the layer of build material, and the delivery device comprising first agent ejecting nozzles at one distance from the build platform and second agent ejecting nozzles at another distance from the build platform.

13. A printer as claimed in claim 11, comprising a carriage controllable by the controller to scan in a horizontal direction over the layer of build material, the delivery device comprising printheads and the carriage comprising mounting sockets for two printheads at two different vertical levels with respect to the layer of build material.

14. A printer as claimed in claim 11, comprising a build platform and a coater to form successive layers of build material on the build platform,
wherein the controller is to
control the coater to form a layer of build material on the build platform,
control the delivery device to selectively deposit droplets of a liquid agent on the layer of build material,
control the build platform to move towards or away from the delivery device, and
control the delivery device to selectively deposit droplets of a liquid agent on the same layer of build material.

15. A three-dimensional (3D) printer for manufacturing a 3D body by selectively solidifying successive layers of build material according to a pattern for each layer of build material, the printer comprising a controller to:
determine a core region and an edge region of the pattern for a layer of build material,
control the printer to deposit droplets of a liquid agent on the layer of build material from a first distance in correspondence with the core region of the pattern, and
control the printer to deposit droplets of the liquid agent on the layer of build material from a second distance in correspondence with the edge region of the pattern.
